(19) United States
(12) Patent Application Publication
(10) Pub. No.: US 2010/0143700 A1
(43) Pub. Date: Jun. 10, 2010

(54) COLD SPRAY IMPACT DEPOSITION SYSTEM AND COATING PROCESS

(76) Inventors: VICTOR K CHAMPAGNE, Dudley, MA (US); Phillip F. Leyman, Oxford, PA (US); Dennis J. Helfritch, Catonsville, MD (US)

Correspondence Address: U S ARMY RESEARCH LABORATORY;ATTN: RDRL-LOC-I, 2800 POWDER MILL RD, ADELPHI, MD, 20783-1197, US

(21) Appl. No.: 12/329,672

(22) Filed: Dec. 8, 2008

(51) Int. Cl. B32B 5/02; B05D 1/12; B05C 19/04

(52) U.S. Cl. 428/323; 427/180; 118/308

(57) ABSTRACT

A cold spray apparatus is provided that includes a nozzle having a converging section and a diverging terminal section. A gas supply meters a majority by atomic percent helium gas to the nozzle at an incident gas temperature of less than 30° Celsius and at an incident velocity of between 2 and 6 MPa. A particulate feeder provides ductile material particulate having a mean x-y-z axially averaged linear dimension of between 0.9 and 95 microns to the nozzle. A composition is also provided that includes a substrate and a coating of ductile metal. The coating has a void density of less than 1% by volume, and an average domain size of between 0.9 and 95 microns. The coating has a compressive residual stress.

### GOVERNMENT INTEREST

The invention described herein may be manufactured, used, and licensed by or for the United States Government.

### FIELD OF THE INVENTION

The present invention in general relates to an impact deposition system for depositing ductile particulate on a substrate at a temperature of less than 30° Celsius and in particular to a simplified carrier gas path to a system nozzle.

### BACKGROUND OF THE INVENTION

There are numerous instances when an adherent metal coating is desired on a substrate. Such coatings are helpful in providing corrosion resistance and conductivity as illustrative modifications to a substrate. Conventional techniques for applying such coatings include sputter coating, electrochemical deposition and explosive welding. Each of these conventional techniques has limited utility owing to attributes of each respective conventional deposition technique. A more recent technique developed to address the shortcomings associated with other conventional deposition techniques is known as cold spray impact deposition.

Conventional cold spray impact deposition uses a gas supply such as helium, air or nitrogen bifurcated to convey a portion of the gas to a heater to heat the gas stream to a temperature of between 20° and 700° Celsius. A conventional prior art system is detailed in FIG. 1. The gas stream entrains ductile material particles in a solid state and typically in a size of from 1 to 50 microns in diameter with the particles being accelerated to supersonic velocities of between 600 and 1000 meters per second through a de Laval nozzle. The particles impact a target substrate with sufficient kinetic energy to cause plastic deformation and consolidation with the underlying material to cause bonding to the substrate and other strata of deformed particles to build up a layer of depositing material. A problem associated with such a conventional system is turbid flow of particulate associated with the convergence of the bifurcated gas streams in the converging portion of the nozzle. Interparticle collisions within the nozzle and inefficient gas usage results. These problems are accentuated with operation at elevated temperatures where nozzle fouling by particles occurs.

Thus, there exists a need for a cold spray coating apparatus and process for applying a metallic spray coating onto a substrate with superior control of particle focus and trajectory towards the substrate. There also exists a need for a coating having very low porosity resulting from a limited number of interparticle interactions during gas mixing associated with conventional cold spray apparatus.

### SUMMARY OF THE INVENTION

A process for applying a ductile material spray coating on a substrate includes feeding a majority by atomic percent helium gas by a single path to a spray nozzle having a converging portion and a diverging terminal portion. In certain desirable embodiments, the inert gas forms a flow at a pressure of between about 2 and about 6 mega Pascal (MPa) incident on an inlet to the converging portion of the nozzle and at a temperature that is desirably less than about 30° Celsius. In certain desirable embodiments, a supply of ductile material particles having a mean x-y-z axially averaged linear dimension of between about 0.9 and about 95 microns is introduced into the nozzle and accelerated to a velocity of greater than about 500 meters per second upon exiting the nozzle. The accelerated particles impact the substrate to apply the ductile material spray coating on the substrate by deforming on impact to form the coating having compressive stress.

A cold spray apparatus is provided that includes a nozzle having a converging section and a diverging terminal section. In one exemplary embodiment, a gas supply meters a majority by atomic percent helium gas to the nozzle at an incident gas temperature of less than 30° Celsius and at an incident velocity of between 2 and 6 MPa. A particulate feeder provides ductile material particulate having a mean x-y-z axially averaged linear dimension of between 0.9 and 95 microns to the nozzle. A composition is also provided that includes a substrate and a coating of ductile metal. Desirably, the coating has a void density of less than about 1 percent by volume, and an average domain size of between about 0.9 and about 95 microns. The coating has a compressive residual stress.

### BRIEF DESCRIPTION OF THE DRAWINGS

The present invention is further described in detail with reference to specific embodiments illustrated in the accompanying drawings which include:

FIG. 1 is a schematic view of a conventional prior art cold spray impact deposition apparatus;

FIG. 2 is a schematic of an inventive cold spray apparatus with particulate feed into the converging portion of the nozzle;

FIG. 3 is a schematic of an inventive cold spray apparatus with particulate feed into the diverging portion of the nozzle;

FIG. 4 is a plot of calculated velocities and temperatures for helium gas and 20 micron aluminum particles as a function of distance traveled through apparatus as depicted in FIG. 2;

FIG. 5 is a plot of calculated velocities and temperatures for helium gas and 20 micron aluminum particles as a function of distance traveled through apparatus as depicted in FIG. 3; and

FIG. 6 is a cross-sectional scanning electron micrograph (SEM) of a 250 micron thick aluminum coating deposited on a magnesium substrate with the apparatus of FIG. 2 and under conditions modeled in the plot of FIG. 4.

### DETAILED DESCRIPTION OF THE PREFERRED EMBODIMENTS

The present invention has utility in forming of coatings of ductile material containing compressive residual stress, as opposed to tensile residual stress associated with coatings produced with elevated temperature feedstock. Additionally, the present invention has utility as a cold spray deposition apparatus that precludes nozzle fouling associated with elevated temperature operation, as well as particle feed into the converging portion of a nozzle. According to one embodiment of the present invention, a majority by atomic percent helium gas stream, by way of a singular path, enters a converging portion of a nozzle and entrains a quantity of ductile material particulate with the gas stream incident on the converging portion of the nozzle being at a temperature of less than 30° Celsius. The helium gas stream is desirably a majority by atomic molar percent helium and is more desirably greater than 90 atomic molar percent helium. Suitable dilutants for helium in the helium gas stream include, but are not limited to, air, hydrogen, nitrogen, and argon. Desirably, the dilutant is hydrogen and is provided below the combustion threshold and desirably below 5 mole percent. Helium and hydrogen are noted as having high gas velocities even at room temperature of 20° Celsius thereby facilitating sonic velocities of greater than 500 meters per second needed for ductile material particulate to operate properly as a cold spray coating deposition apparatus with hydrogen stabilizing oxygen-sensitive particulate. The present invention is contrasted to the prior art of exemplary prior art FIG. 1 which resorted to nitrogen gas stream heating to promote particle velocities of greater than 500 meters per second and bifurcated gas streams with one branch of the incident gas stream entraining ductile material particulate while the second branch passes through a heat exchange coil before rejoinder in or in proximity to the converging portion of a nozzle. As such, the single path flow of a gas flow in the present invention affords simplified operation, inhibits gas flow turbulence, and eliminates the need for gas flow heaters and heating. Additionally, a unitary incident gas stream simplifies modeling and operation of nozzle performance during cold spray impact deposition. A particle feed is provided intermediate between the gas supply and the converging portion of the nozzle or directly into the diverging terminal portion of the nozzle, or a combination thereof. It is appreciated that the gas flow in all or part being conveyed through a particle feeder is not considered as a bifurcation from the single path nature of an inventive apparatus.

Particles suitable for cold spray deposition according to the present invention desirably have a mean x-y-z axially averaged linear dimension of between 0.9 and 95 microns. Suitable particles operative in the present invention have a variety of shapes including, but not limited to, spherical, oblate and prolate rods, and granular. It is noted that a spherical particle has a linear dimension that is equivalent in all three orthogonal directions corresponding to the x, y and z axes. More desirably, the particles have a mean x-y-z axially averaged linear dimension of between 5 and 50 microns. Ductile material particulate includes metals and metal alloys that have a percent elongation before fracture of at least 5 percent as measured by ASTM EM8-04. Exemplary ductile material particles illustratively include, but are not limited to, aluminum, gold, copper, silver, titanium, stainless steel, and mild steel particles, and combinations thereof. It is appreciated that a mixture of particles of varying composition are readily applied according to the present invention to provide a mixed composition coating. Additionally, it should also be appreciated that the composition of ductile material particulate accelerated by an inventive apparatus to form a coating on a substrate can be dynamically varied to form a graded composition that varies in composition with the thickness of the coating. Further, it is appreciated that a non-ductile particulate is readily cold spray deposited in concert with a quantity of ductile material particulate in which non-ductile particulate can embed with non-ductile material particulate such as ceramics, non-ductile metals, and non-ductile metal alloys being encapsulated within a shell of ductile material. Desirably, the non-ductile material particles and any non-ductile material particles encapsulated within ductile material also have a mean x-y-z axially averaged linear dimension of between 0.9 and 95 microns, and more desirably between 5 and 50 microns.

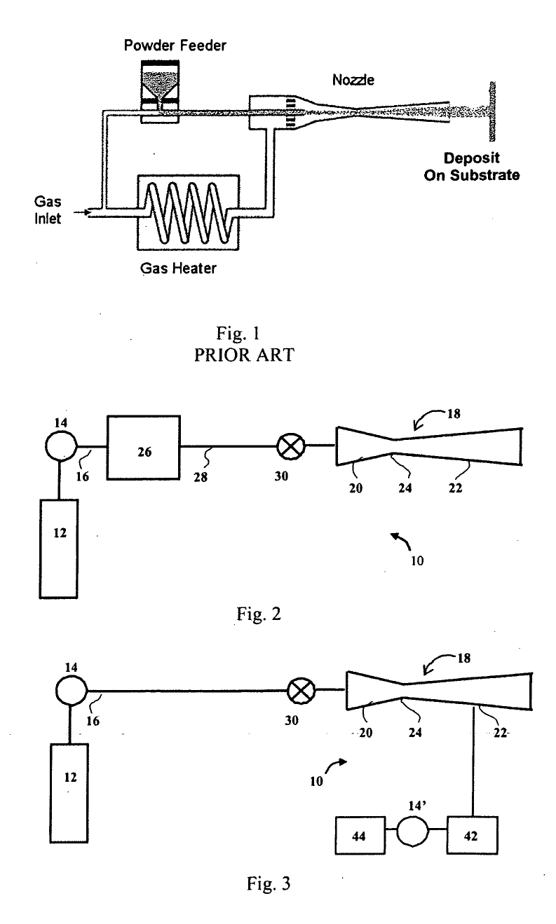

Referring now to FIG. 2, an inventive cold spray apparatus is depicted generally at 10. The apparatus 10 includes a pressurized gas source 12 containing a majority by atomic percent helium, desirably greater than 90 atomic percent helium, with the remainder of the gas desirably being predominantly air, nitrogen, argon, or hydrogen or a mixture thereof. Desirably, a dilutant gas, if present in the gas source 12, is hydrogen below the explosion threshold. In the illustrated embodiment, the gas source 12 is a standard K-type cylinder of pure helium. However, other prefilled pressurized cylinders or other gas sources as known in the art may be used. A regulator 14 is provided in fluid communication with gas exiting the gas source 12 and controls gas pressure within conduit 16. In this first illustrated embodiment, conduit 16 is provided with a single pathway to a nozzle 18. The nozzle 18 has a converging section 20 and a diverging section 22 with an optional minimal constriction 24 intermediate between the converging section 20 and diverging section 22. A high pressure ductile material particle feeder 26 is provided in line intermediate between conduit 16 and the nozzle 18. The high pressure ductile material particle feeder 26 allows gas within the conduit 16 to entrain ductile material particulate from the feeder 26 and carry the particulate through conduit 28 and past flow control valve 30 and into the converging section 20 of nozzle 18. The feeder works on a volumetric principle that directly controls the powder feed rate by the speed of a pick-up wheel. When the feeder is in operation, holes in the variable speed wheel fill with powder. When a filled hole rotates above a gas flow port, the powder in the hole is entrained by the gas flow.

The apparatus 10 in delivering gas from gas source 12 to the nozzle 18 without transiting a heater provides a single flow path for gas from the gas source 12 and nozzle 18 thereby achieving less turbidity within the converging portion 20 of the nozzle 18 and as a result inhibits inter-particle impact prior to impacting a substrate in the path of the terminal diverging section 22 of the nozzle 18.

Through hand-held or robotic control of the nozzle 18 and the use of a braided flex hose as conduit 16, controlled patterns of coating deposition are readily produced. Additionally, through resort to a deposition mask further control of deposition geometry is obtained.

Typical feed rates of ductile material particulate entrained by gas passing through the feeder 26 are between 0.01 and 18 grams of particulate per minute with a gas flow rate of 30 m³/hour so as to achieve a particle velocity upon exiting the terminal diverging portion 22 of the nozzle 18 of greater than 500 meters per second and desirably between 600 and 1200 meters per second. It is appreciated that the optimal particle velocity for cold spray coating deposition includes factors such as mean x-y-z axially averaged linear dimension of the ductile material particulate, particle density, gas pressure, and particle metering rate into the gas flow.

Referring now to FIG. 3, an alternative inventive apparatus is depicted generally at 40 where like numerals correspond to the descriptions to those reference numerals used with respect to FIG. 2. The apparatus 40 provides a single gas flow path between the gas source 12 and the converging portion 20 of the nozzle 18 by way of regulator 14, conduit 16 and control valve 30. The inventive apparatus 40 in lacking a heater secondary pathway between the gas source 12 and the nozzle 18 also affords nonturbid flow within the converging section 20 and precludes particle contamination within the control valve 30, as well as the converging portion 20 and minimal constriction 24 of nozzle 18. A low gas pressure ductile material particle feeder 42. The low pressure particle feeder 42 is in fluid communication with a gas source 44 by way of a regulator 14′ delivers ductile material particulate with regulator 14 providing an inlet pressure to the feeder 42 of between 0.1 and 0.6 MPa. One suggested, commercially available low pressure feeder that is suitable for use in the present inventive system and in the corresponding process includes, but is not limited to, a 4 MP powder feeder from Sulzer Metco of Winterthur, Switzerland.

In an exemplary process of the present invention to apply a ductile material spray coating onto a substrate, a majority by atomic percent helium gas is fed into the converging portion of a nozzle and incident pressure of between 2 and 7 MPa and at a temperature of less than 30° Celsius and without resort to a heater. A supply of ductile material particles is supplied into the gas before entering the converging portion of the nozzle or alternatively produced under a low pressure of between 0.1 and 0.6 MPa into the diverging portion of the nozzle so as to accelerate the ductile material particles to a velocity of more than 500 meters per second at the nozzle outlet and into a substrate proximal to the nozzle outlet. Ductile material particles undergo plastic deformation upon contact with the substrate or previously deposited and plastically deformed particles to form a coating of very low porosity.

The present invention is further detailed with respect to the following examples that describe a few exemplary embodiments. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations.

### EXAMPLE 1

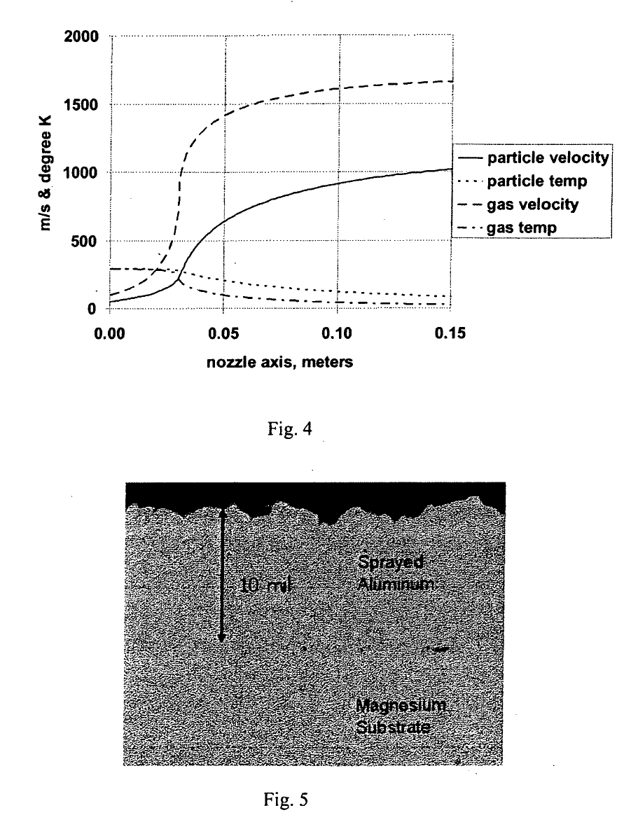

Using apparatus 10 of FIG. 2, pure helium gas in a K-type cylinder at an initial temperature of 20° Celsius and pressure of 2.8 MPa in the conduit 16 flows at 34 m³/hour entrains spherical 20 micron-aluminum particles at a rate of 3 grams/minute exit the nozzle with sufficient velocity to achieve good impact plastic deformation on a magnesium substrate positioned 10 centimeters incident to the nozzle. The aluminum particles had a mean x-y-z axially averaged linear dimension of 20 micron. These depositions have also been successfully reproduced with aluminum (AlClad) and steel substrates. The calculated velocities and temperatures for the gas and the aluminum particles as a function of distance traveled through a nozzle is depicted in FIG. 4 for a nozzle having a converging portion with a 6.35 mm circular inlet that extends for 7.62 mm and then tapers over 6.35 mm to a minimal constriction of 1.0 mm and thereafter expanding smoothly to a terminal nozzle diverging circular cross section having a diameter of 3.56 mm over a length of 12.2 cm from the minimal constriction. An SEM cross section of a 250 micron thick aluminum coating so produced on the magnesium substrate is shown in FIG. 5. The aluminum coating has a bond strength to the substrate of greater than 60 MPa and a pore volume of less than 1%.

### EXAMPLE 2

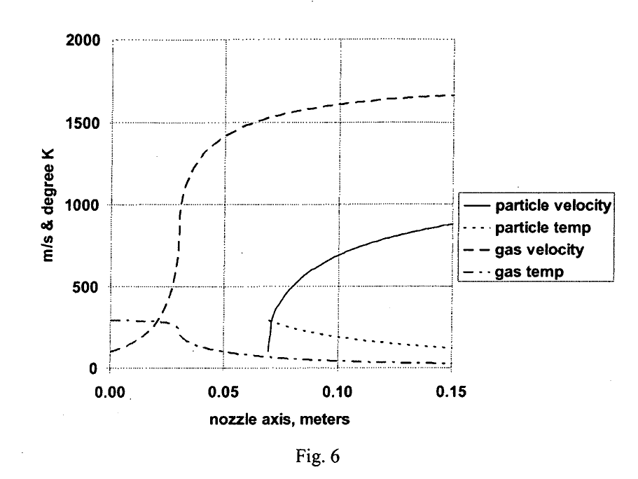

Using the apparatus of FIG. 3 with the same helium gas conditions and 20 micron spherical aluminum particles also fed at a rate of 3 grams per minute, with the exception that the 20 micron aluminum particles are now fed into the low pressure, divergent section, the calculated velocities and temperatures for the gas and the particles as a function of distance traveled through the nozzle is depicted in FIG. 6. The aluminum particles are noted to exit the nozzle at 900 meters per second and yield a coating similar to that depicted in FIG. 5 with respect to Example 1.

The foregoing description is illustrative of particular embodiments of the invention, but is not meant to be a limitation upon the practice thereof. The following claims, including all equivalents thereof, are intended to define the scope of the invention.

1. A process for applying a coating on a substrate comprising:
feeding a majority by atomic percent helium gas through a spray nozzle by a path consisting of a single conduit, said nozzle having a converging portion and a diverging terminal portion, said gas forming a flow at a pressure of between about 2 and about 6 MPa at an inlet to the converging portion and at a temperature of less than about 30° Celsius;
introducing a supply of ductile material particles having a mean x-y-z axially averaged linear dimension between about 0.9 and about 95 microns into said nozzle so as to accelerate said particles to a velocity of greater than about 500 meters per second; and
impacting the substrate with said particles to apply a coating on the substrate.

2. The process of claim 1 wherein said gas comprises less than 10 atomic percent of a dilutant of hydrogen, air, nitrogen, or argon.

3. The process of claim 1 wherein temperature is between about 15° and about 25° Celsius.

4. The process of claim 1 wherein said particles are predominantly spherical.

5. The process of claim 1 wherein the mean x-y-z axially averaged linear dimension is between 5 and 50 microns.

6. The process of claim 1 wherein the particles are aluminum particles or particles made from an aluminum-containing alloy.

7. The process of claim 1 wherein the particles are accelerated to a velocity of between about 700 and about 1000 meters per second.

8. The process of claim 1 wherein the substrate is magnesium or steel.

9. A cold spray deposition apparatus comprising:
a nozzle having a converging section and a diverging terminal section;
a majority by atomic percent helium gas supply;
a path consisting of a single conduit between said gas supply and said nozzle delivering a gas from said gas supply to an inlet to the converging section of said nozzle at a pressure of between about 2 and about 6 MPa and independent of exposure to a heater; and
a particle feeder providing ductile material particles having a mean x-y-z axially averaged linear dimension of between about 0.9 and about 95 microns to said nozzle.

10. The apparatus of claim 9 wherein said gas supply is at least about 90 atomic percent helium.

11. The apparatus of claim 9 wherein said conduit comprises a braided flex hose.

12. The apparatus of claim 1I further comprising a robotic arm moving said nozzle in preselected directions.

13. The apparatus of claim 9 wherein said particle feeder introduces ductile material particulate into the converging section of said nozzle.

14. The apparatus of claim 9 wherein said particle feeder introduces said particles into the diverging terminal section of said nozzle.

15. The apparatus of claim 14 wherein the portal connecting said particle feeder to the diverging terminal section is located between about 30 and about 70 percent of the distance between the minimal constriction and the nozzle outlet.

16. A composition comprising:
a substrate; and
a coating of ductile material particles having plastically deformed domains having domain volumes equivalent to impacting particles having a mean x-y-z axially averaged linear dimension of between about 0.9 and about 95 microns, said coating under compressive stress.

17. The composition of claim 16 wherein said coating is aluminum or an aluminum alloy.

18. The composition of claim 16 wherein said substrate is aluminum.

19. The composition of claim 16 wherein said substrate is ceramic.

20. The composition of claim 16 wherein said substrate is steel.
